(19) United States
(12) Patent Application Publication
(10) Pub. No.: US 2026/0187369 A1
(43) Pub. Date: Jul. 2, 2026

(54) SYSTEM AND METHOD FOR INTERACTING WITH A RETRIEVAL-AUGMENTED GENERATION SYSTEM

(71) Applicant: Centre for Perceptual and Interactive Intelligence (CPII) Limited, Hong Kong (CN)

(72) Inventors: Mei Ling Helen Meng, Hong Kong (CN); Pengfei Liu, Hong Kong (CN); Ka Hei Cheng, Hong Kong (CN); Charlie Chen, Hong Kong (CN); Yu Yi Wong, Hong Kong (CN)

(21) Appl. No.: 19/004,882

(22) Filed: Dec. 30, 2024

(51) Int. Cl. G06F 40/284; G06F 40/30

(52) U.S. Cl. CPC G06F 40/284; G06F 40/30

(57) ABSTRACT

System and method for interacting with a retrieval-augmented generation system. The method includes receiving a textual prompt, retrieving information associated with the textual prompt based at least in part on the textual prompt, generating input data based at least in part on the textual prompt and the retrieved information, and generating an output at least in part by applying the input data to a machine learning model of the retrieval-augmented generation system. The machine learning model is configured using at least prompt engineering to determine the output based at least in part on the input data. The method further includes generating a quality score of the output with reference to the input data, and outputting the output and an indication of the quality score.

### TECHNICAL FIELD

This invention relates to systems and methods for interacting with a retrieval-augmented generation system.

### BACKGROUND

Retrieval-augmented generation (RAG) is a known technique that utilizes information retrieval and natural language processing (e.g., generation) to provide an output based on an input. The quality of the output may be determined based on accuracy and/or relevance of the output with respect to the input.

### SUMMARY OF THE INVENTION

In a first aspect, there is provided a computer-implemented method for interacting with a retrieval-augmented generation system. The computer-implemented method comprises: receiving a textual prompt, retrieving information associated with the textual prompt based at least in part on the textual prompt, generating input data based at least in part on the textual prompt and the retrieved information, and generating an output at least in part by applying the input data to a machine learning model of the retrieval-augmented generation system. The machine learning model is configured using at least prompt engineering to determine the output based at least in part on the input data. The computer-implemented method further comprises: generating a quality score of the output with reference to the input data, and outputting the output and an indication of the quality score.

For example, the textual prompt may correspond to a query (e.g., a question) and the output may correspond to a response (e.g., an answer) to the query. For example, the computer-implemented can support real-time chatbot application.

In one embodiment of the first aspect, the indication of the quality score comprises: the quality score, a rating derived from the quality score, an indicator with a colour corresponding to the quality score, and/or an indicator with a colour corresponding to the rating derived from the quality score.

In one embodiment of the first aspect, retrieving information associated with the textual prompt comprises retrieving an electronic file (e.g., an electronic document) comprising text associated with the textual prompt.

In one embodiment of the first aspect, the output comprises a textual output.

In one embodiment of the first aspect, the quality score is associated with a lexical similarity between the textual output and related text of the retrieved information, a semantic similarity between the textual output and related text of the retrieved information, or both. Optionally, the quality score may be associated with one or more other metrics.

In one embodiment of the first aspect, the computer-implemented further comprises generating a lexical score associated with the lexical similarity. The quality score may be generated based at least in part on the lexical score.

In one embodiment of the first aspect, the lexical score is generated based at least in part on calculating Jaccard similarity or F1 score.

In one embodiment of the first aspect, generating the lexical score comprises: filtering (removing) stop words from the textual output and the related text of the retrieved information, lemmatizing the filtered output and the filtered related text of the retrieved information, and generating the lexical score at least in part by calculating an F1 score associated with the lemmatized and filtered output and the lemmatized and filtered related text of the retrieved information.

In one embodiment of the first aspect, the calculating of the F1 score is based on:

$$\frac{( 2 \times precision \times recall )}{precision + recall}$$

where

$$precision = \frac{W}{R} , recall = \frac{W}{S} ,$$

W corresponds to a number of overlapping words between the lemmatized and filtered output and the lemmatized and filtered related text of the retrieved information, R corresponds to a number of words in the lemmatized and filtered output, and S corresponds to a number of words in the lemmatized and filtered text of the retrieved information.

In one embodiment of the first aspect, the computer-implemented further comprises outputting an indication of the lexical score.

In one embodiment of the first aspect, the indication of the lexical score comprises: the lexical score, a rating derived from the lexical score, an indicator with a colour corresponding to the lexical score, and/or an indicator with a colour corresponding to the rating derived from the lexical score.

In one embodiment of the first aspect, the computer-implemented further comprises generating a semantic score associated with the semantic similarity. The quality score may be generated based at least in part on the semantic score.

In one embodiment of the first aspect, generating the semantic score comprises: generating the semantic score at least in part by calculating a cosine similarity between embeddings of the textual output and embeddings of the related text of the retrieved information.

In one embodiment of the first aspect the computer-implemented further comprises outputting an indication of the semantic score.

In one embodiment of the first aspect, the indication of the semantic score comprises: the semantic score, a rating derived from the semantic score, an indicator with a colour corresponding to the semantic score, and/or an indicator with a colour corresponding to the rating derived from the semantic score.

In one embodiment of the first aspect, the computer-implemented further comprises generating a lexical score associated with the lexical similarity and generating a semantic score associated with the semantic similarity. The quality score may be generated based at least in part on the lexical score and the semantic score.

In one embodiment of the first aspect, the quality score is generated based at least in part on:

$${w}_{1} \cdot ( lexical score ) + {w}_{2} \cdot ( semantic score )$$

where w₁ is a weighting for the lexical score and w₂ is a weighting for the semantic score.

In one embodiment of the first quality score=w₁·(lexical score)+w₂·(semantic score). Optionally, w₁+w₂=1. Optionally, w₂ is greater than or equal to w₁.

In one embodiment of the first aspect, the computer-implemented further comprises providing a user interface associated with the retrieval-augmented generation system. The user interface may include a graphical user interface (GUI).

In one embodiment of the first aspect, the textual prompt is received via the user interface.

In one embodiment of the first aspect, the computer-implemented further comprises displaying the output and the indication of the quality score in the user interface.

In one embodiment of the first aspect, the computer-implemented further comprises outputting an indication of the lexical score and an indication of the semantic score, and displaying the output, the indication of the quality score, the indication of the lexical score, and the indication of the semantic score in the user interface.

In one embodiment of the first aspect, the machine learning model comprises a language model such as a large language model (LLM).

In one embodiment of the first aspect, the machine learning model comprises a generative language model.

In one embodiment of the first aspect, the machine learning model comprises a unimodal machine learning model.

In a second aspect, there is provided a system comprising one or more processors and memory storing a computer program configured to be executed by the one or more processors. The computer program comprises instructions for performing or facilitating performing of the computer-implemented method of the first aspect. The system may further comprise a display for displaying the user interface and related information and data.

In a third aspect, there is provided a carrier medium carrying computer readable instructions arranged to cause one or more processors to perform or facilitate performing of the computer-implemented method of the first aspect. In one example, the carrier medium comprises a computer-readable medium. In one example, the computer-readable medium is a non-transitory computer-readable storage medium, which stores a computer program executable by the one or more processors. The computer program comprises instructions for performing or facilitating performing of the computer-implemented method of the first aspect.

In a fourth aspect, there is provided a computer program comprising instructions which, when the program is executed by a computer, cause the computer to carry out the computer-implemented method of the first aspect.

Other features and aspects will become apparent by consideration of the following detailed description and the accompanying drawings. Any feature(s) described herein in relation to one aspect or embodiment may be combined with any other feature(s) described herein in relation to any other aspect or embodiment, as appropriate and applicable.

### BRIEF DESCRIPTION OF THE DRAWINGS

Some embodiments will now be described, with reference to the accompanying drawings, in which:

FIG. 1 is a flowchart illustrating a method for interacting with a retrieval-augmented generation system in one embodiment;

FIG. 2 is a flowchart illustrating a method for interacting with a retrieval-augmented generation system in one embodiment;

FIG. 3 is a screenshot illustrating a user interface of a retrieval-augmented generation system in one embodiment;

FIG. 4 is a schematic diagram illustrating example indicators associated with quality scores for a response provided by a retrieval-augmented generation system in one embodiment;

FIG. 5 is a schematic diagram illustrating an interaction (hovering) with a score component in a user interface of a retrieval-augmented generation system in one embodiment;

FIG. 6 is a schematic diagram illustrating an interaction (clicking) with a score component in a user interface of a retrieval-augmented generation system in one embodiment;

FIG. 7 is a schematic diagram illustrating an interaction (cursor leaving) with a score component in a user interface of a retrieval-augmented generation system in one embodiment; and

FIG. 8 is a block diagram of a data processing system in one embodiment.

### DETAILED DESCRIPTION OF THE PREFERRED EMBODIMENTS

Reliable responses are important for the practical deployment of retrieval-augmented generation (RAG) systems. However, ensuring that the machine learning model (such as LLM) of the RAG system can consistently generate factual and reliable responses is a significant challenge, for example in the knowledge-intensive question-answering domains like education and healthcare. In these cases, general-purpose machine learning model (such as general-purpose LLM) may lack training on specialized vertical knowledge and this would increase the risk of hallucinated responses. This issue also persists in RAG systems, where the retrieved context for response generation may be incomplete or missing in the provided knowledge base. Thus, neither open-domain LLMs nor RAG systems can guarantee consistently accurate and reliable responses in these critical applications.

Embodiments disclosed herein provide a scoring approach that can be applied to improve the reliability of knowledge-intensive RAG applications. In some embodiments, the system and method may combine lexical and semantic metrics to evaluate quality of responses by performing sentence-level comparisons between source documents and response output. In some embodiments, the system and method are designed to actively engage users in the evaluation process. In some embodiments, the system and method are intuitive (user friendly), can enhance user experience, and/or can improve response reliability.

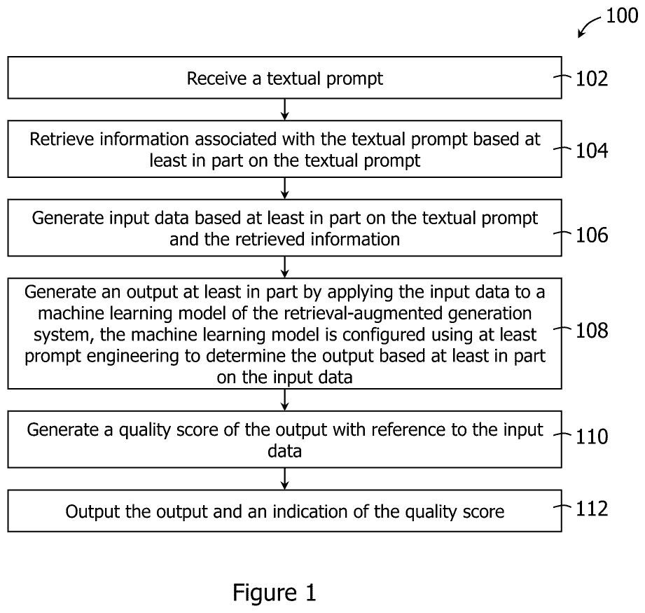

FIG. 1 shows a method 100 for interacting with a retrieval-augmented generation system in one embodiment. Method 100 is a computer-implemented method and may be performed using one or more processors.

Method 100 includes, in 102, receiving a textual prompt. In one embodiment, the textual prompt may be received via a user interface associated with a retrieval-augmented generation system or its machine learning model. For example, the textual prompt may correspond to a query (e.g., presented in the form of question or sentence). In one embodiment, the textual prompt may include a string of text.

Method 100 includes, in 104, retrieving information associated with the textual prompt based at least in part on the textual prompt. For example, the information associated with the textual prompt may be retrieved in response to receiving the textual prompt. The information may be retrieved from a database. In one embodiment, 104 includes retrieving an electronic file (e.g., an electronic document) containing text associated with the textual prompt. The electronic file or its text may represent knowledge that can be used for generating a response to the query of the textual prompt.

Method 100 includes, in 106, generating input data based at least in part on the textual prompt and the retrieved information. The input data can be applied to a machine learning model for processing.

Method 100 includes, in 108, generating an output at least in part by applying the input data to a machine learning model of the retrieval-augmented generation system. The machine learning model is configured using at least prompt engineering to determine the output based at least in part on the input data. The output may include a textual output. For example, the output may correspond to a response (e.g., in the form of answer) to the query. For example, the machine learning model may include a language model such as a large language model (LLM). For example, the machine learning model may include a generative language model. For example, the machine learning model may include a unimodal machine learning model.

Method 100 includes, in 110, generating a quality score of the output with reference to the input data. The quality score may reflect the accuracy and/or relevance of the output with respect to the input data. The quality score may be associated at least with: a lexical similarity between the textual output and related text of the retrieved information, a semantic similarity between the textual output and related text of the retrieved information, or both. The quality score may be generated based at least in part on a lexical score associated with the lexical similarity and/or a semantic score associated with the semantic similarity.

Method 100 includes, in 112, outputting the output and an indication of the quality score. The indication of the quality score may include the quality score, a rating derived from the quality score, an indicator with a colour corresponding to the quality score, and/or an indicator with a colour corresponding to the rating derived from the quality score.

In one embodiment, method 100 may further include providing a user interface, such as a graphical user interface, associated with the machine learning model. In 102, the textual prompt may be received via the user interface. In one embodiment, method 100 may further include displaying the output and the indication of the quality score in the user interface.

A person skilled in the art appreciates that method 100 is merely an example embodiment and method 100 can be modified (e.g., to include additional steps/operations) to provide other embodiments.

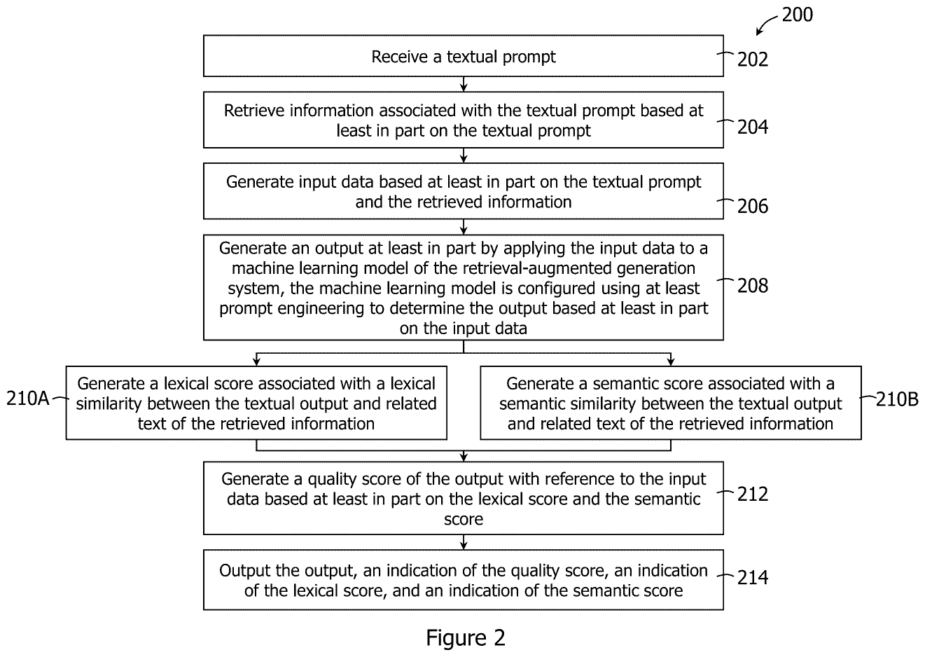

FIG. 2 shows a method 200 for interacting with a retrieval-augmented generation system in one embodiment. Method 200 is a computer-implemented method and may be performed using one or more processors.

Method 200 includes, in 202, receiving a textual prompt. 202 in method 200 may be similar or identical to 102 in method 100. For brevity, details are not repeated here.

Method 200 includes, in 204, retrieving information associated with the textual prompt based at least in part on the textual prompt. 204 in method 200 may be similar or identical to 104 in method 100. For brevity, details are not repeated here.

Method 200 includes, in 206, generating input data based at least in part on the textual prompt and the retrieved information. 206 in method 200 may be similar or identical to 106 in method 100. For brevity, details are not repeated here.

Method 200 includes, in 208, generating an output at least in part by applying the input data to a machine learning model of the retrieval-augmented generation system. 208 in method 200 may be similar or identical to 108 in method 100. For brevity, details are not repeated here.

Method 200 includes, in 210A, generating a lexical score associated with a lexical similarity between the textual output and related text of the retrieved information. In one embodiment, the lexical score is generated based at least in part on calculating Jaccard similarity or F1 score. In one embodiment, the lexical score is generated at least in part by filtering (removing) stop words from the textual output and the related text of the retrieved information, lemmatizing the filtered output and the filtered related text of the retrieved information, and generating the lexical score at least in part by calculating an F1 score associated with the lemmatized and filtered output and the lemmatized and filtered related text of the retrieved information. In one example, the F1 score may be calculated based on

$$\frac{( 2 \times precision \times recall )}{precision + recall}$$

where

$$precision = \frac{W}{R} , recall = \frac{W}{S} ,$$

W corresponds to a number of overlapping words between the lemmatized and filtered output and the lemmatized and filtered related text of the retrieved information, R corresponds to a number of words in the lemmatized and filtered output, and S corresponds to a number of words in the lemmatized and filtered text of the retrieved information.

Method 200 includes, in 210B, generating a semantic score associated with a semantic similarity between the textual output and related text of the retrieved information. In one embodiment, the generating of the semantic score is at least in part by calculating a cosine similarity between embeddings of the textual output and embeddings of the related text of the retrieved information.

Method 200 includes, in 212, generating a quality score of the output with reference to the input data based at least in part on the lexical score and the semantic score. In one embodiment, the quality score is generated based at least in part on:

$${w}_{1} \cdot ( lexical score ) + {w}_{2} \cdot ( semantic score )$$

where w₁ is a weighting for the lexical score and w₂ is a weighting for the semantic score. For example, quality score=w₁·(lexical score)+w₂·(semantic score). For example, w₁+w₂=1. For example, w₂ is greater than or equal to w₁.

Method 200 includes, in 214, outputting the output, an indication of the quality score, an indication of the lexical score, and an indication of the semantic score. The indication of the lexical score may include the lexical score, a rating derived from the lexical score, an indicator with a colour corresponding to the lexical score, and/or an indicator with a colour corresponding to the rating derived from the lexical score. The indication of the semantic score may include the semantic score, a rating derived from the semantic score, an indicator with a colour corresponding to the semantic score, and/or an indicator with a colour corresponding to the rating derived from the semantic score.

In one embodiment, method 200 may further include providing a user interface, such as a graphical user interface, associated with the machine learning model. In 202, the textual prompt may be received via the user interface. In one embodiment, method 200 may further include displaying the output, the indication of the quality score, the indication of the lexical score, and the indication of the semantic score in the user interface.

A person skilled in the art appreciates that method 200 is merely an example embodiment and method 200 can be modified (e.g., to include additional steps/operations, to omit one or more steps/operations) to provide other embodiments. For example, the quality score may be generated based on either the lexical score or the semantic score (not both) and a corresponding one of the operation 210A, 210B may be omitted. For example, the specific calculations for the scores can be modified (e.g., using different formula or equations). For example, the specific values used in the calculations may be modified (e.g., using different values). For example, 210A and 210B may be performed simultaneously or sequentially.

In one embodiment, there is provided a system and method for enhancing reliability in a retrieval-augmented generation system with a confidence scoring model combining lexical and semantic metrics for assessing response quality. This embodiment can be considered as an example implementation of the method 100, 200.

The rapid development of large language models (LLMs) has resulted in improvements in these models. However, the adoption of LLMs in educational and professional fields has raised questions about the reliability and validity of their generated responses. It is known generative LLMs may be prone to hallucinations and can generate misinformation.

Retrieval-augmented generation (RAG) can improve the performance of LLMs by integrating external truths with parameterized knowledge and reducing the incidence of hallucinations. However, it is still possible for RAG to provide incorrect or contradictory results (e.g., generations). While some RAG may generate natural language text as output, it is difficult to assess the factual correctness and confidence in the output. There is a need to provide an evaluation metric that can be used for indicating whether the generated content is likely to be incorrect or relevant.

In this respect, depending on the use case, not every metric may be suitable as there may be various limitations depending on the application. In one example in which a commercial black-box LLM is used for generation, only textual output may be returned to the end user. This means that the logits and attention from the backend LLM cannot be used for evaluation of generation quality (or quality of the output). Also, existing black-box LLM confidence evaluation methods such as verbalized confidence and self-consistency may not be suitable for or applicable to real-time chatbot applications. In particular, it may be necessary to wait for multiple generations, evaluations, and potential regenerations of responses for a single turn of confidence evaluation. This may be time consuming or inefficient, hence is undesirable in an environment where the user expects quick (e.g., real-time or instant) responses.

Based on the above, in this embodiment, there is provided a relatively simple method that can accurately and timely evaluate a response (quality of the output). This embodiment can be applied to real-time chat applications and it utilizes the generated text output from the LLM response. This embodiment further provides an intuitive user interface for interacting with the RAG or its LLM. This embodiment may enhance user experience and/or provide reliable responses.

Uncertainty and confidence metrics can be used in assessing the reliability of generated responses (output provided by RAG or its LLM). This can be important in determining the likelihood of incorrect content. Some existing approaches to response validity evaluation is discussed below.

One existing approach utilizes contrastive semantic similarity (CSS) to extract insightful semantic relations between text pairs, in which METEOR (Metric for Evaluation of Translation with Explicit ORdering) is leveraged as an evaluation criterion for generated responses of LLMs to better capture semantic similarities. This approach can be used for estimating uncertainty.

Some existing approaches include calculating the predictive uncertainty and generating multiple samples for similarity comparison to determine confidence. For example, an existing approach suggests using a natural language inference (NLI) classifier to predict logits for entailment and contradiction between generated samples, using spectral clustering to group similar samples, calculating the graph Laplacian of the clusters, and estimating generation confidence based on the eccentricity of the graph Laplacian.

Some existing approaches are non-logit-based approaches for confidence elicitation. These include verbalized confidence, consistency-based confidence, and hybrid approach. Verbalized confidence generated by the model is found to be prone to issues of overconfidence, even when the word choice of the model is explicitly uncertain. Consistency-based confidence may outperform verbalized methods but it could require more time and resources compared to other techniques. A combination of verbalized and consistency-based confidence methods may complement each other to further improve calibration and performance. However, these prompt-based methods of confidence elicitation do not indicate the source of truth of the model, making them unsuitable for retrieval-based generation in some cases.

In the context of addressing hallucination issues in open-domain LLMs, in one example, five categories of existing methods for estimating factual confidence have been identified and evaluated: trained probes, sequence probability, verbalization, surrogate token probability, and output consistency. In this example, the trained probe method emerges as the most reliable estimator for LLM factual confidence, showing generalizability across models and out-of-domain data. Despite the promising results of using trained probes as confidence estimators, the requirement for access to multiple layers of the internal state of the model makes the method incompatible with many existing industry leading black-box LLMs which only provide the final textual output through the APIs.

Regarding the hallucination problem in RAG systems, one existing method for detecting hallucinations leverages mechanistic interpretability, which decouples the utilization of parametric knowledge of the LLM and external context, thus allowing the calculation of an external context score and a parametric knowledge score. However, this method also requires access to the internal state of the LLM to access the attention heads of the model.

Unlike these existing approaches, the method and system in this embodiment do not depend on logits or the internal states of an LLM. Instead, the method and system in this embodiment introduces a confidence scoring model that combines lexical and semantic metrics to assess response quality, which enables the users to interact with the RAG system more reliably and/or effectively.

In this embodiment, there is provided a method that calculates a confidence score through a weighted combination of scores from lexical and semantic metrics. The method determines whether the two sentences (response sentence and source sentence, obtained from the textual output and text from the retrieved information respectively) are related based at least on lexical metrics and semantic metrics.

In this embodiment, lexical metrics measure the overlaps of words used between two sentences. The more overlaps between a response sentence and a source sentence, the more likely that they are related with each other. Methods that may be used to calculate a score from this overlap includes the Jaccard similarity and the ROUGE-1 F1 score.

In some cases, stop words may inflate the score by increasing the count while inflection may lower the score by representing the same word in a different form. To address this issue, in this embodiment, a stop word list is used to filter out (remove or discard) the commonly used stop words and the text (after filtering) is lemmatized with the spacy package before calculating the overlaps.

In this embodiment, the F1 score can be calculated based on:

$$F 1 score = \frac{( 2 \times precision \times recall )}{precision + recall}$$

where the number of overlapping words is W, the number of words in response sentence is R and the number of words in source sentence is S, precision is obtained by W/R and recall is obtained by W/S.

Turning now to semantic metrics. As different words can be used to express the same meaning, there is a need to compare the semantic similarity between the response sentence and the source sentence in addition to the overlaps of words between them. This comparison can be performed by measuring the cosine similarity between the embeddings of the two sentences, which can be normalized first before being multiplied together to obtain the cosine similarity value between 0 and 1.

In this embodiment, both the lexical and semantic metrics are useful for determining the relation between the response sentence and the source sentence. Hence, both lexical and semantic scores are considered in determining whether the two sentences are sufficiently related. In this embodiment, a simple weighted sum (i.e., a weighted lexical score plus a weighted semantic score) is applied to obtain an overall score (also referred to as confidence score or quality score). In one example, the weights add up to 1. In some cases, the lexical metric may output a lower score due to the requirements of overlaps and this tends to drag down the overall score. In one example, the weights are set to be 0.8 for semantic score and 0.2 for lexical score.

In some cases, to ensure that sentences too unrelated are ignored while not removing them excessively, a threshold (of the overall score) can be set. In this example, the threshold is set at 0.5. Sentences with an overall score below the threshold are considered not directly supported in the source document. These sentences may be hallucinatory outputs from the LLM of the RAG system, which the users should pay attention to.

In this embodiment, the overall score is converted to a rating in the range from 1 to 5, using the following formula:

$$⌈ 5 \cdot {score}^{α} ⌉$$

where α=1.2 and the rating is rounded up to the nearest integer. The power function means that lower scores reflect more poorly in the ratings.

To convert the scores and metrics into a more comprehensive aid for users to evaluate the validity of generated content (output provided by the RAG system or its LLM), a user interface designed to facilitate its implementation onto system interfaces is provided in this embodiment.

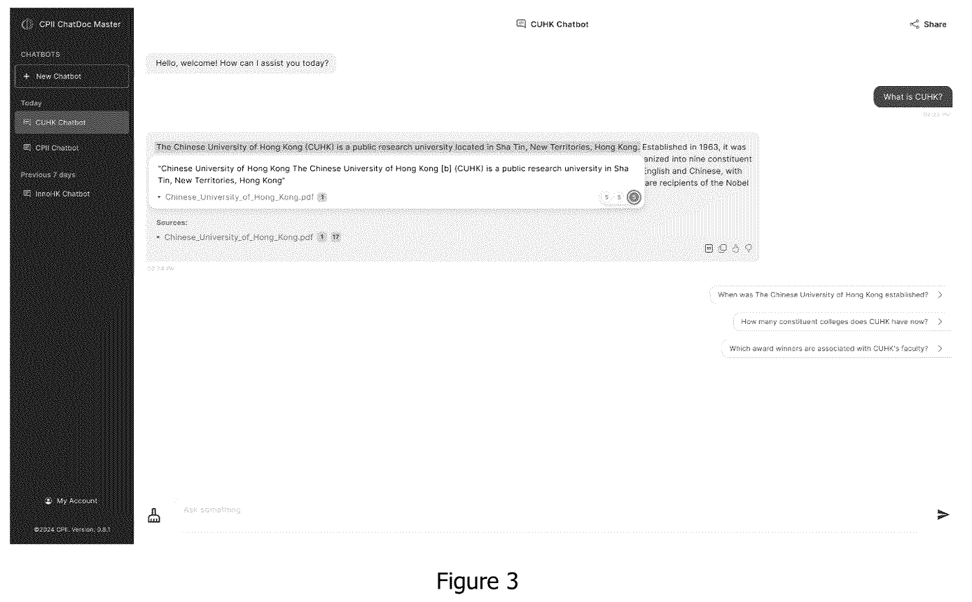

In this embodiment, to further verify the functionality of the response evaluation method, the user interface is implemented into a system, namely CPII ChatDoc Master, which is an AI-powered tool that helps users to analyze their documents and websites, providing answers to their questions. FIG. 3 shows a screenshot of the user interface of CPII ChatDoc Master.

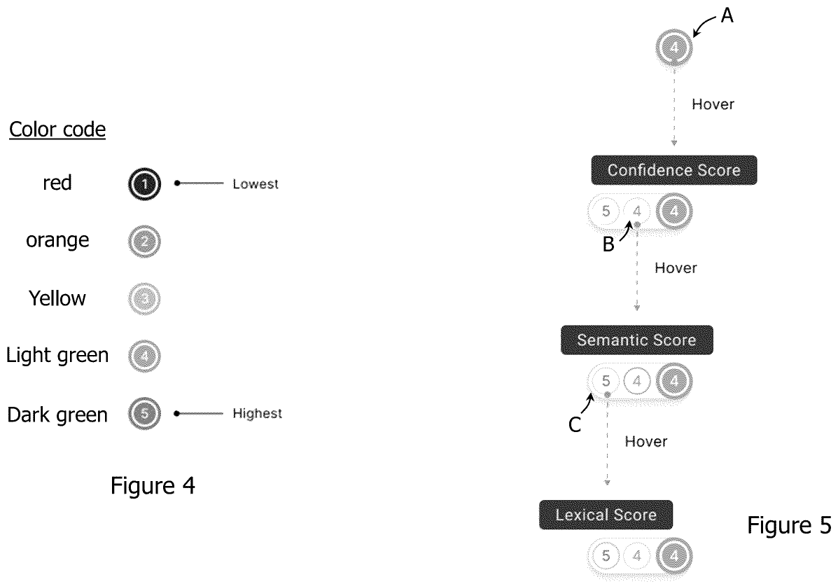

In this embodiment, based on the scale of three scores (lexical score, semantic score, overall score), in this example ratings from 1 to 5, five colours are selected to indicate the five different levels of confidence score regarding the response. FIG. 4 shows an example of these indicators (including the rating and a color code).

The user interface is designed to facilitate interaction with the user. In this embodiment, the user can interact with the score panel.

The interaction in this embodiment includes the following user actions: hover to expand/view, click to view, and cursor leave to collapse.

For example, the users can hover the cursor over the “Confidence Score” indicator A in the score panel to expand the view of “Semantic Score” indicator B and “Lexical Score” indicator C, which also indicates the affiliation between the confidence score and the two corresponding scores. When users hover the cursor over each of these scores, the corresponding tooltips will be shown to indicate the respective names of the scores. This is illustrated in FIG. 5.

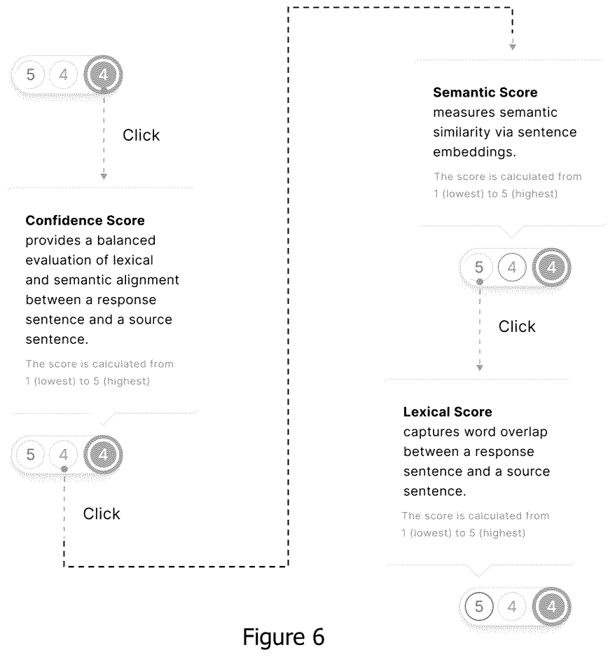

For example, the users can click on the score component to view the corresponding infotip in explaining the definitions of the terms. This is illustrated in FIG. 6.

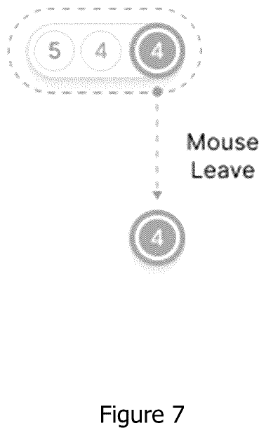

For example, the users can move the cursor away from the scores or the score panel to collapse the score components. This is illustrated in FIG. 7.

In this embodiment, the user interface design emphasizes an intuitive user experience and adherence to established heuristics, particularly focusing on flexibility and efficiency. In this embodiment, the user interface, in particular the score panel, incorporates a responsive button-like state that triggers hover actions, providing users with immediate feedback and enhancing interactivity. Additionally, tooltips and infotips are integrated to clarify complex concepts related to the features, ensuring that users can easily see the essential information without feeling overwhelmed. In line with the heuristic of flexibility and efficiency, the design presents three levels of information (three scores) within a single, compact display element. This allows for a condensed format that fits seamlessly within a citation box or panel, ensuring that it does not obstruct the ongoing chatbot conversations while still delivering valuable context and insights to the user.

An experiment (case study) is performed based on the above embodiment. In this experiment, a chatbot, named CUHK Chatbot, is developed based on the Wikipedia page of CUHK (in PDF format). The chatbot answers questions about CUHK, with responses reliably aligned to the source document. As shown in Table 1, each response-source pair demonstrates alignment with the motivation and design of the above embodiment. Each sentence pair is evaluated with a lexical score, a semantic score, and a final confidence score, all on a scale of 1 to 5.

As observed in Table 1, the response is generally correct when the confidence is high. The score can point to a reasonable source for a response when it exists but still requires that the word choice to be very similar and thus with a higher lexical score. This should serve as an aid for the end user to find the relevant original items as well as to judge whether the answer is correct or reliable or trustworthy.

TABLE 1
Example response-source sentence pairs with the corresponding lexical
score, semantic score, and confidence score in one example experiment.

| Sentence Pairs | | Scores | | |
|---|---|---|---|---|
| Response Sentence | Source Sentence | Lexical | Semantic | Confidence |
| The Chinese University of | The Chinese University of Hong | 5 | 5 | 5 |
| Hong Kong (CUHK) is a | Kong (CUHK) is a public research | | | |
| public research university | university in Sha Tin, New | | | |
| located in Sha Tin, New | Territories, Hong Kong | | | |
| Territories, Hong Kong. | | | | |
| Established in 1963, it was | Established in 1963 as a | 4 | 5 | 4 |
| initially formed as a | federation of three colleges - | | | |
| federation of three | Chung Chi College, New Asia | | | |
| colleges: Chung Chi College, | College, and United College, it is | | | |
| New Asia College, and | Hong Kong's second-oldest | | | |
| United College | university. | | | |
| CUHK is the second-oldest | CUHK is now organised into nine | 4 | 5 | 4 |
| university in Hong Kong and | constituent colleges and eight | | | |
| is now organized into nine | academic faculties, and remains | | | |
| constituent colleges and | the only collegiate university in | | | |
| eight academic faculties. | Hong Kong | | | |
| It is the only collegiate | The university operates in both | 4 | 4 | 4 |
| university in Hong Kong and | English and Chinese, though | | | |
| operates in both English | classes are taught in English. | | | |
| and Chinese, with classes | | | | |
| primarily taught in English. | | | | |
| Notably, CUHK is the only | Four Nobel laureates are | 3 | 5 | 4 |
| tertiary institution in Hong | associated with the university, | | | |
| Kong that has faculty | and it is the only tertiary | | | |
| members who are | institution in Hong Kong with | | | |
| recipients of the Nobel | recipients of the Nobel Prize, | | | |
| Prize, Turing Award, Fields | Turing Award, Fields Medal, and | | | |
| Medal, and Veblen Prize. | Veblen Prize sitting as faculty in | | | |
| | residence. | | | |

The above embodiment provides a confidence scoring approach designed to enhance response reliability in RAG systems, which may be particularly suitable for knowledge-intensive domains such as education and healthcare. The embodiment provides a response quality evaluation metric and an interactive user interface design. In this embodiment, by leveraging both lexical and semantic metrics for sentence-level comparisons, the evaluation metric can effectively assess response quality against source documents. Additionally, the method and user interface provided in this embodiment are intuitive, easy to implement, and user-friendly, enabling users to reliably evaluate responses. The method and system in this embodiment may improve user experience by providing a clear indication of response reliability.

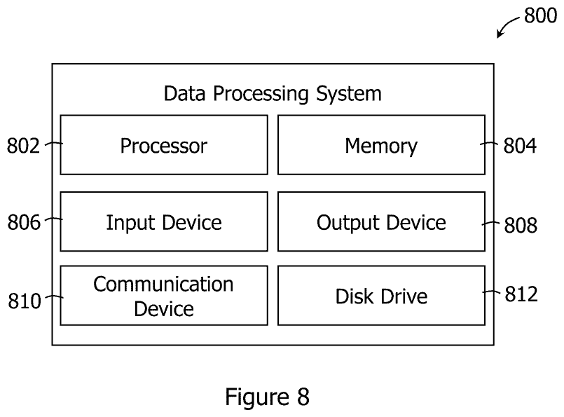

FIG. 8 shows a data processing system 800 in one embodiment. FIG. 8 only illustrates main components of the data processing system 800. The data processing system 800 can be used to perform data processing operations such as any of those disclosed herein. For example, the data processing system 800 can be arranged to perform any of the disclosed method (e.g., method 100, method 200, method discussed with reference to FIGS. 3 to 7), in part or entirely. The data processing system 800 is arranged to support interaction with a retrieval-augmented generation system. The data processing system 800 may be arranged to operate a retrieval-augmented generation system.

The data processing system 800 includes components necessary to receive, store, and execute appropriate computer instructions, commands, and/or codes. The data processing system 800 includes a processor 802 and a memory 804. The processor 802 may include one or more of: CPU(s), MCU(s), GPU(s), NPU(s), VPU(s), TPU(s), logic circuit(s), Raspberry Pi chip(s), digital signal processor(s) (DSP), application-specific integrated circuit(s) (ASIC), field-programmable gate array(s) (FPGA), and digital and/or analog circuitry (or circuitries) configured to interpret program instructions, to execute program instructions (e.g., associated with any of the methods or operations disclosed herein), and/or to process signals and/or information and/or data. The memory 804 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data are stored in the memory 804. For example, computer instructions for executing or facilitating executing of the method steps or operations disclosed herein (e.g., those in the methods disclosed herein) may be stored in the memory 804. The processor 802 and memory 804 may be integrated, or the processor 802 and memory 804 may be separated (and operably connected).

Optionally, the data processing system 800 further includes one or more input devices 806. Examples of the input device 806 include: keyboard, mouse, stylus, image scanner, microphone, tactile/touch input device (e.g., touch sensitive screen), image/video input device (e.g., camera), etc. The input device 806 can be used to receive input (e.g., location input) from a user. The input device 806 may provide a user interface, such as a graphical user interface, for interacting with a user (e.g., for receiving the textual prompt).

Optionally, the data processing system 800 further includes one or more output devices 808. Examples of the output device 808 include: display (e.g., monitor, screen, projector, etc.), speaker, headphone, earphone, printer, etc. The display may include an LCD display, a LED/OLED display, or other suitable display, which may or may not be touch sensitive. The output device 808 may provide a user interface, such as a graphical user interface, for interacting with a user (e.g., for presenting information or data (e.g., output, scores) to a user).

The data processing system 800 may further include one or more disk drives 812 which may include one or more of: solid state drive, hard disk drive, optical drive, flash drive, magnetic tape drive, etc. A suitable operating system may be installed in the data processing system 800, e.g., on the disk drive 812 or in the memory 804. The memory 804 and the disk drive 812 may be operated by the processor 802.

The data processing system 800 may further include a communication device 810 for establishing one or more communication links with one or more computing devices, such as servers, database, personal computers, terminals, tablets, phones, watches, internet connected (e.g., IoT) devices, or other computing devices. The communication device 810 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, 6G, or the like) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data.

The processor 802, the memory 804 (optionally the input device(s) 806, the output device(s) 808, the communication device(s) 810 and the disk drive(s) 812, if present) may be connected with each other, directly or indirectly, through any of: a bus, a Peripheral Component Interconnect (PCI), such as PCI Express, a Universal Serial Bus (USB), an optical bus, or other like structure. In one embodiment, at least some of these components may be connected wirelessly, e.g., through a network, such as the Internet, a cloud computing network, an edge computing network, etc.

A person skilled in the art appreciates that the data processing system 800 is merely an example embodiment and the data processing system 800 can be modified (e.g., to include additional components, to omit one or more components, to include alternative components, etc.) to provide other embodiments.

Although not required, the embodiments described with reference to the Figures can be implemented as an application programming interface (API) or as a series of libraries for use by a developer or can be included within another software application, such as a terminal or computer operating system or a portable computing device operating system. Generally, as program modules include routines, programs, objects, components and data files assisting in the performance of particular function, the skilled person will understand that the functionality of the software application may be distributed across multiple routines, objects and/or components to achieve the same functionality desired herein. Further, where methods and systems are either wholly implemented by computing system or partly implemented by computing systems, any appropriate computing system architecture may be utilized. This may include stand-alone computers, network computers, dedicated or non-dedicated hardware devices. Where the terms “computing system” and “computing device” are used, these terms are intended to include any appropriate arrangement of computer or information processing hardware capable of implementing the function described.

In one embodiment, there is provided a carrier medium carrying computer readable instructions arranged to cause one or more processors to perform or facilitate performing of a computer-implemented method according to an embodiment (such as that disclosed herein). The carrier medium may include a computer-readable medium, such as a non-transitory computer-readable storage medium which stores a computer program executable by the one or more processors. The computer program comprises instructions for performing or facilitating performing of the computer-implemented method according to the embodiment.

In one embodiment, there is provided a computer program comprising instructions which, when the program is executed by a computer, cause the computer to carry out a computer-implemented method according to an embodiment (such as that disclosed herein).

It will be appreciated by a person skilled in the art that variations and/or modifications may be made to the described and/or illustrated embodiments to provide other embodiments. The described/or illustrated embodiments should therefore be considered in all respects as illustrative, not restrictive.

Unless otherwise specified, terms of degree such that “generally”, “about”, “substantially”, or the like, are used herein to account for one or more of the following: manufacture tolerance, degradation, trend, tendency, imperfect practical condition(s), etc.

1. A computer-implemented method for interacting with a retrieval-augmented generation system, comprising:
receiving a textual prompt;
retrieving information associated with the textual prompt based at least in part on the textual prompt;
generating input data based at least in part on the textual prompt and the retrieved information;
generating an output at least in part by applying the input data to a machine learning model of the retrieval-augmented generation system, the machine learning model configured using at least prompt engineering to determine the output based at least in part on the input data;
generating a quality score of the output with reference to the input data; and
outputting the output and an indication of the quality score.

2. The computer-implemented method of claim 1, wherein the indication of the quality score comprises:
the quality score;
a rating derived from the quality score;
an indicator with a colour corresponding to the quality score; and/or
an indicator with a colour corresponding to the rating derived from the quality score.

3. The computer-implemented method of claim 2, wherein:
retrieving information associated with the textual prompt comprises retrieving an electronic file comprising text associated with the textual prompt; and
the output comprises a textual output.

4. The computer-implemented method of claim 3, wherein the quality score is associated with:
a lexical similarity between the textual output and related text of the retrieved information; and/or
a semantic similarity between the textual output and related text of the retrieved information.

5. The computer-implemented method of claim 4, wherein:
the computer-implemented further comprises generating a lexical score associated with the lexical similarity; and
the quality score is generated based at least in part on the lexical score.

6. The computer-implemented method of claim 5, wherein the lexical score is generated based at least in part on calculating Jaccard similarity or F1 score.

7. The computer-implemented method of claim 6, wherein generating the lexical score comprises:
filtering stop words from the textual output and the related text of the retrieved information;
lemmatizing the filtered output and the filtered related text of the retrieved information; and
generating the lexical score at least in part by calculating an F1 score associated with the lemmatized and filtered output and the lemmatized and filtered related text of the retrieved information.

8. The computer-implemented method of claim 7, wherein the calculating of the F1 score is based on:
$$\frac{( 2 \times precision \times recall )}{precision + recall}$$
where
$$precision = \frac{W}{R} , recall = \frac{W}{S} ,$$
W corresponds to a number of overlapping words between the lemmatized and filtered output and the lemmatized and filtered related text of the retrieved information, R corresponds to a number of words in the lemmatized and filtered output, and S corresponds to a number of words in the lemmatized and filtered text of the retrieved information.

9. The computer-implemented method of claim 8, wherein:
the computer-implemented further comprises outputting an indication of the lexical score; and
the indication of the lexical score comprises:
the lexical score;
a rating derived from the lexical score;
an indicator with a colour corresponding to the lexical score; and/or
an indicator with a colour corresponding to the rating derived from the lexical score.

10. The computer-implemented method of claim 9, wherein:
the computer-implemented further comprises generating a semantic score associated with the semantic similarity; and
the quality score is generated based at least in part on the semantic score.

11. The computer-implemented method of claim 10, wherein generating the semantic score comprises:
generating the semantic score at least in part by calculating a cosine similarity between embeddings of the textual output and embeddings of the related text of the retrieved information.

12. The computer-implemented method of claim 11, wherein:
the computer-implemented further comprises outputting an indication of the semantic score; and
the indication of the semantic score comprises:
the semantic score;
a rating derived from the semantic score;
an indicator with a colour corresponding to the semantic score; and/or
an indicator with a colour corresponding to the rating derived from the semantic score.

13. The computer-implemented method of claim 4, wherein:
the computer-implemented further comprises generating a lexical score associated with the lexical similarity and generating a semantic score associated with the semantic similarity; and
the quality score is generated based at least in part on the lexical score and the semantic score.

14. The computer-implemented method of claim 13, wherein the quality score is generated based at least in part on:
$${w}_{1} \cdot ( lexical score ) + {w}_{2} \cdot ( semantic score )$$
where w₁ is a weighting for the lexical score and w₂ is a weighting for the semantic score.

15. The computer-implemented method of claim 14, wherein:
$$quality score = {w}_{1} \cdot ( lexical score ) + {w}_{2} \cdot ( semantic score )$$
$$and$$
$${w}_{1} + {w}_{2} = 1.$$

16. The computer-implemented method of claim 15, wherein:
the computer-implemented further comprises providing a user interface associated with the retrieval-augmented generation system;
the textual prompt is received via the user interface; and
the computer-implemented further comprises
outputting an indication of the lexical score and an indication of the semantic score, and
displaying the output, the indication of the quality score, the indication of the lexical score,
and the indication of the semantic score in the user interface.

17. The computer-implemented method of claim 1, wherein:
the computer-implemented further comprises providing a user interface associated with the retrieval-augmented generation system;
the textual prompt is received via the user interface; and
the computer-implemented further comprises displaying the output and the indication of the quality score in the user interface.

18. The computer-implemented method of claim 1, wherein the machine learning model comprises a language model.

19. The computer-implemented method of claim 1, wherein the machine learning model comprises a generative language model.

20. A system comprising:
one or more processors; and
memory storing a computer program configured to be executed by the one or more processors;
wherein the computer program comprises instructions for performing or facilitating performing of the computer-implemented method of claim 1.
